(19) United States
(12) Patent Application Publication
(10) Pub. No.: US 2025/0061624 A1
(43) Pub. Date: Feb. 20, 2025

(54) DIGITAL CONTENT COEDITING

(71) Applicant: Adobe Inc., San Jose, CA (US)

(72) Inventors: Michael Scott Vitrano, New York, NY (US); Tai Benjamin Luxon, San Diego, CA (US); Stephen James Guilhamet, Mountain View, CA (US); Sonova M. Middleton, Brooklyn, NY (US); Robert Hedin Gardner, Brooklyn, NY (US); John J. Metzger, Redmond, WA (US); Foster Thomas Brereton, Arcadia, CA (US); Barkin Aygun, Bend, OR (US)

(73) Assignee: Adobe Inc., San Jose, CA (US)

(21) Appl. No.: 18/451,695

(22) Filed: Aug. 17, 2023

(51) Int. Cl. G06T 11/60; G06F 3/04845

(52) U.S. Cl. CPC G06T 11/60; G06F 3/04845

(57) ABSTRACT

Digital content coediting techniques are described. In an implementation, an edit input specifying an edit to digital content and an action identifier is assigned to the edit. An element identifier of an element of the digital content that is a subject of the edit of the element is obtained along with a previous action identifier identifying a previous edit associated with the element, e.g., as a pair. An edited content region is detected of the digital content corresponding to the edit a candidate edit event is generated including the action identifier, the element identifier, the previous action identifier, and the edited content region.

### BACKGROUND

Digital content coediting is used to support collaboration by a plurality of entities in digital content creation and editing. As part of this, techniques are utilized to resolve conflicts between edits made by different entities, e.g., as caused by concurrent edits to a same portion of the digital content.

Conventional techniques used in conflict resolution, however, are specialized and as such are typically incompatible for use with legacy applications. Further, conventional techniques are confronted with technical challenges caused by complexity in models used to define the digital content, an amount of data used to store the digital content, and so forth.

### SUMMARY

Digital content coediting techniques are described. In an implementation, an edit input specifying an edit to digital content and an action identifier is assigned to the edit. An element identifier of an element of the digital content that is a subject of the edit of the element is obtained along with a previous action identifier identifying a previous edit associated with the element, e.g., as a pair. An edited content region is detected of the digital content corresponding to the edit a candidate edit event is generated including the action identifier, the element identifier, the previous action identifier, and the edited content region.

A broadcast edit event is then received that identifies an edit to an element of digital content. The broadcast edit event, for instance, is generated based on the candidate edit event and transmitted in an order as received by a service provider system from client device. An element identifier of the element and a previous action identifier identifying a previous edit made to the element in the broadcast edit event are compared to an element identifier of the element and an action identifier of the element identifying a previous edit made to the element for a local version of the digital content. A determination is then made as to whether the element identifier and the previous action identifier of the broadcast edit event correspond to the element identifier and the previous action identifier of the local version of the digital content. If so, the edit is applied to the local version of the digital content based on the determination and the local version of the digital content as having the edit is displayed in a user interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ digital content coediting and conflict resolution techniques described herein.

FIG. 2 depicts a system in an example implementation showing operation of a first content editing module of FIG. 1 in greater detail as making an edit to a first local version of digital content and generating a candidate edit event based on the edit.

FIG. 3 depicts an example implementation of a user interface output as configured to edit digital content configured as a digital image.

FIG. 4 depicts a system in an example implementation showing receipt by a service provider system of a candidate edit event of FIG. 2 and generation of broadcast edit event which is broadcast to client devices that participate in a digital content coediting session.

FIG. 5 is a flow diagram depicting an algorithm as a step-by-step procedure in an example implementation of operations performable for accomplishing a result of generation of a candidate edit event responsive to receipt of an edit input to edit digital content as part of digital content coediting.

FIG. 6 depicts a system in an example implementation in which a broadcast edit event as transmitted by the service provider system of FIG. 4 is processed by a second client device as part of a digital content coediting session.

FIG. 7 depicts a system in an example implementation in which a broadcast edit event as transmitted by the service provider system of FIG. 4 is processed by the first client device that originated the candidate edit event as part of a digital content coediting session.

FIG. 8 depicts an example implementation of output of representations indicating status of edits made to a local version of digital content.

FIG. 9 is a flow diagram depicting an algorithm as a step-by-step procedure in an example implementation of operations performable for accomplishing a result of receipt of a broadcast edit event, conflict determination, and resolution as part of a digital content coediting session.

FIG. 10 illustrates an example system including various components of an example device that can be implemented as any type of computing device as described and/or utilize with reference to the previous figures to implement embodiments of the techniques described herein.

### DETAILED DESCRIPTION

### Overview

Digital content coediting is used to support concurrent editing by multiple entities with a single item of digital content. During a digital content editing session, for instance, changes made by entities to the digital content are communicated (e.g., in real time) between client devices employed by the entities to support collaboration. In some instances, however, conflicts may occur between changes made by the entities, e.g., different edits to a same portion of the digital content that are made at approximately the same time before those edits may be communicated between the devices.

Conventional techniques used as part of conflict resolution, however, are specialized and therefore lack compatibility with legacy applications and object models employed by those applications. Further, conventional conflict resolution techniques encounter inefficiencies caused by complex items of digital content and/or that consume significant amounts of data storage. As a result, conventional conflict resolution techniques as employed in digital content coediting encounter computational and network inefficiencies, increased power consumption, and limited applicability.

Accordingly, digital content coediting techniques are described. These techniques support coediting functionality to legacy applications and complex object models. The digital content coediting techniques also support improved computational efficiency and reduced power consumption for items of digital content that consume significant amounts of data storage, e.g., for large digital images having multiple layers, each supporting a multitude of pixels.

In one or more examples, an element-based conflict resolution mechanism is described. Consider an example in which a first and second client device participate in a digital content coediting session as facilitated by a service provider system. An item of digital content (e.g., a digital image having a plurality of layers) is edited in this example by the first and second client devices concurrently and the service provider system is tasked with communicating edits between the two client devices. To do so, the first and second client devices include first and second client coedit modules and the service provider system includes a coedit manager module.

The item of digital content is separated into subcomponents for separate modification, which are referred to as “elements” in the following discussion. In an example in which the item of digital content is a digital image, for instance, the elements are formable as separate layers of the digital image.

Once an edit is detected at the first client device, a first client coedit module assigns an action identifier as a unique identifier to the edit, i.e., the “action.” The first client coedit module also determines an element (or set of elements) that is a subject of the edit and obtains an element identifier and a previous action identifier associated with the element. The element identifier identifies the element (e.g., the layer) and the previous action identifier is generated as a unique identifier of a previous edit made to the element that is a subject of the edit. In this way, the pair of element identifier and previous action identifier describe “what” is modified by the edit and the edit and action identifier define the edit, itself. A candidate edit event is then generated by the first client device and communicated to the service provider system that identifies the edit, includes the action identifier, and the pair formed from the element identifier and previous action identifier.

The service provider system, through use of the coedit manager module imposes an event ordering to the candidate edit events as received from the respective client devices. The service provider system, for instance, generates broadcast edit events based on the candidate edit events as received by the service provider system. The broadcast edit events are then broadcast in an order, in which, the candidate edit events are received by the system. In this way, the coedit manager module imposes a strict ordering of the edits as made to the digital content.

Upon receipt of a broadcast edit event by the second client device, for instance, a pair formed by element identifier and previous action identifier pair in the broadcast edit event are compared with a pair formed by an element identifier and a previous action identifier of a local version of the digital content maintained at the second client device. If the pairs correspond to each other, and therefore the edit is to be made to a correct version of the element, a second coedit module of the second client device applies the edit to the digital content and the previous action identifier for the element identifier is updated.

If the pairs do not correspond to each other, this means that the edit specified in the broadcast edit event affects a same element that is also being edited by another entity, e.g., the second entity. In other words, the first entity's edit in the broadcast edit event concurrently affects a same element that is being edited locally by the second entity. Because of the event ordering imposed by the service provider system, however, it is determined that the broadcast edit event occurred first. Therefore, a conflict is detected, which may be resolved in a variety of ways, such as to “back out” a local edit, provide a notification for manual correction, and so on.

“Delta” techniques are also usable as part of optimization of edit event generation and communication, thereby improving computational and storage efficiency and reducing power consumption. Continuing with the previous example, the first client device generates a delta between a before-state of an in-memory representation of the digital content before the edit and an after-state of the in-memory representation of the digital content after the edit. The delta is then split into two pieces, a patch which describes edits made to the digital content and binary data. Binary data includes raster data describing color values of pixels involved in the edit as referenced by the path, color profile data, and so on. The first client coedit module, for instance, identifies a portion of an element that is a subject of the edit (e.g., a part of a layer) and the binary data is based on that portion.

The patch and the binary data are then communicated to the service provider system. In an implementation, the patch describing the changes is included as part of the broadcast edit event while the binary data is maintained independently and separately at the service provider system. Therefore, the second client coedit module may first employ the broadcast edit event and corresponding patch to determine whether the edit to the local version of the digital content is permitted (i.e., is not a conflict) and if so the binary data is obtained. If the edit is not permitted due to a conflict, the binary data is not communicated from the service provider system, thereby conserving network and client device resources with increased responsiveness.

By splitting the transmission into a lightweight schema of the patch and a heavyweight binary store of the binary data, network bandwidth is optimized and therefore further reduces an opportunity for a conflict caused by multiple edit events being communicated at the same time. The client devices are also configurable to perform validation techniques to ensure that the delta is supported as well as support display of a menu (e.g., panel) in a user interface including representations of a status of edits made to the local version of the digital content, further discussion of which is included in the following sections.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Environment

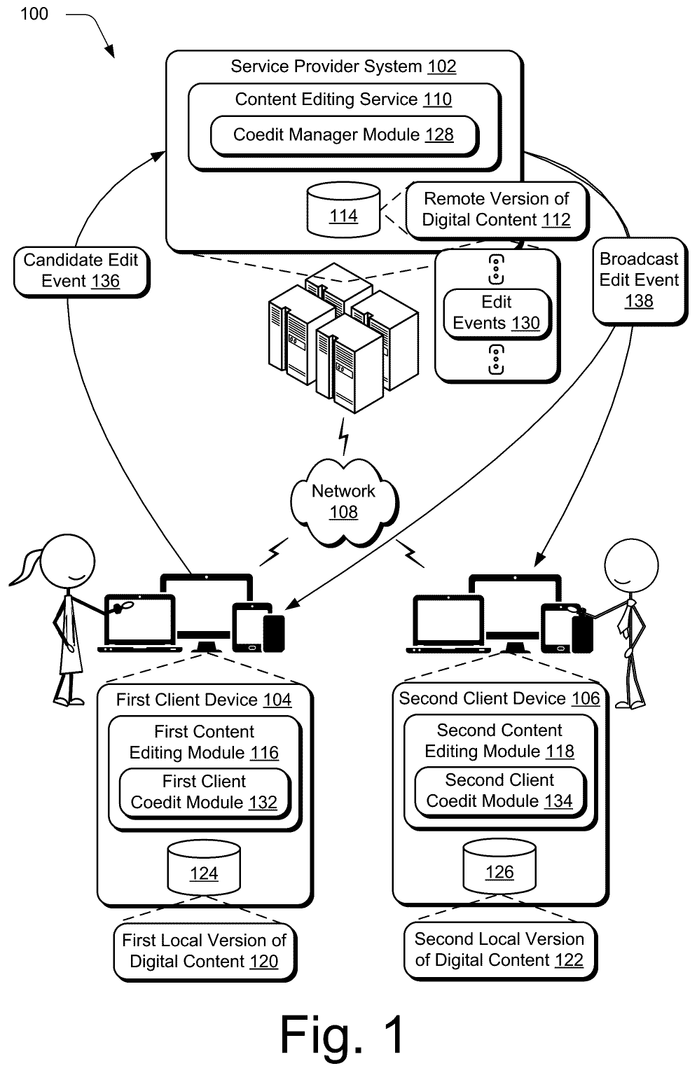

FIG. 1 is an illustration of a digital medium environment 100 in an example implementation that is operable to employ digital content coediting and conflict resolution techniques described herein. The illustrated environment 100 includes a service provider system 102, a first client device 104, and a second client device 106 that are communicatively coupled, one to another, via a network 108. Computing devices that implement the service provider system 102 and the first and second client devices 104, 106 are configurable in a variety of ways.

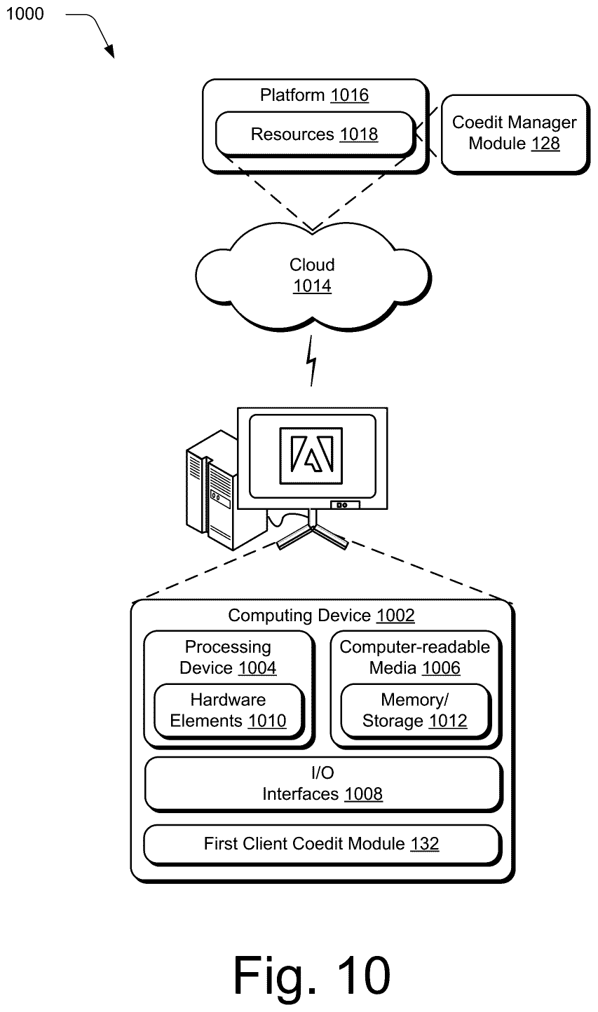

Computing devices, for instance, are configurable as a desktop computer, a laptop computer, a mobile device (e.g., assuming a handheld configuration such as a tablet or mobile phone), and so forth. Thus, computing devices range from full resource devices with substantial memory and processor resources (e.g., personal computers, game consoles) to a low-resource device with limited memory and/or processing resources (e.g., mobile devices). Additionally, although a single computing device is shown and described, a computing device is also representative of a plurality of different devices, such as multiple servers utilized by a business to perform operations “over the cloud” as described in FIG. 10.

The service provider system 102 is illustrated as including a content editing service 110 that is configured to support digital content coediting between the first and second client devices 104, 106 over the network 108. The content editing service 110, for instance is illustrated as maintaining a remote version of digital content 112 in a storage device 114. The first client device 104 and the second client device 106 include, respectively, a first content editing module 116 and a second content editing module 118.

The first and second content editing modules 116, 118 are configured to edit, respectively, a first local version of digital content 120 and a second local version of digital content 122, which are illustrated as maintained in respective local storage devices 124, 126. The digital content is configurable in a variety of ways, such as a digital image (e.g., digital document), digital video, digital audio, and so forth. Accordingly, a variety of edits are also supported by the first and second content editing modules 116, 118, e.g., to change color values of pixels in a digital image, a spectrogram of digital audio, frames of a digital video, words in a digital document, and so forth.

The content editing service 110 includes a coedit manager module 128 that is representation of functionality to implement a coediting session between the first and second client device 104, 106. A coediting session supports an ability for multiple entities to edit a same item of digital content during a same session, e.g., simultaneously in real time or near real time. To do so in this example, the coedit manager module 128 employs edit events 130 that describe edits made to local versions of the digital content. The edit events 130 are generated and utilized by a first client coedit module 132 and a second client coedit module 134 to control which edits are permitted to respective local versions of the digital content and resolve conflicts.

A first content editing module 116 in the illustrated example makes an edit to a first local version of the digital content 120. In response, the first client coedit module 132 generates a candidate edit event 136 that is communicated to the service provider system 102 via the network 108. The coedit manager module 128, as previously described, implements a strict ordering of edit events as received by the system from respective client devices, which are then broadcast in that order as a broadcast edit event 138, e.g., both to the first client device 104 that generated the candidate edit event 136 as well as the second client device 106. The first and second client coedit modules 132, 134 are then tasked with detecting conflicts and applying the edits, and thus is performed locally by the respective client devices for the first and second local versions of the digital content 120, 122 in this example.

In this way, use of the edit events 130 and orderings imposed by the coedit manager module 128 and conflict resolution implemented locally by the first and second client coedit modules 132, 134 support live coediting functionality that may be retroactively applied to legacy applications and support use of complex document models, which is not possible in conventional techniques as further described below. Further discussion of these and other examples is included in the following sections and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Candidate Edit Event Generation

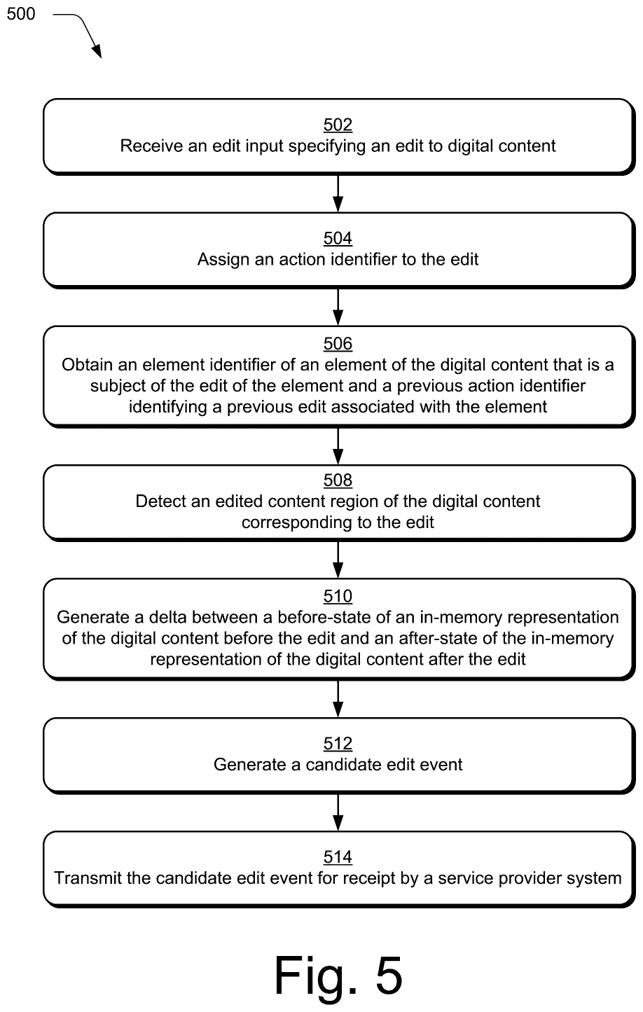

The following discussion describes candidate edit event generation techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform algorithm. In portions of the following discussion, reference will be made in parallel to FIG. 5, which is a flow diagram depicting an algorithm 500 as a step-by-step procedure in an example implementation of operations performable for accomplishing a result of generation of a candidate edit event responsive to receipt of an edit input to edit digital content as part of digital content coediting.

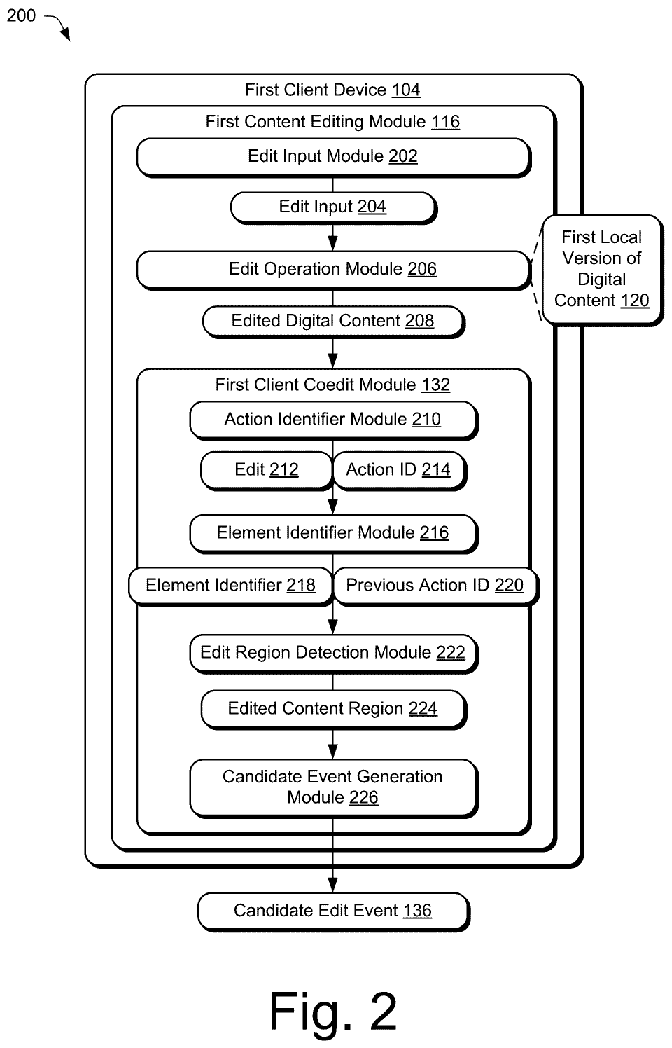

FIG. 2 depicts a system 200 in an example implementation showing operation of the first content editing module 116 in greater detail as making an edit to a first local version of digital content 120 and generating a candidate edit event 136 based on the edit. To begin in this example, an edit input module 202 receives an edit input 204. The edit input specifies an edit to digital content (block 502).

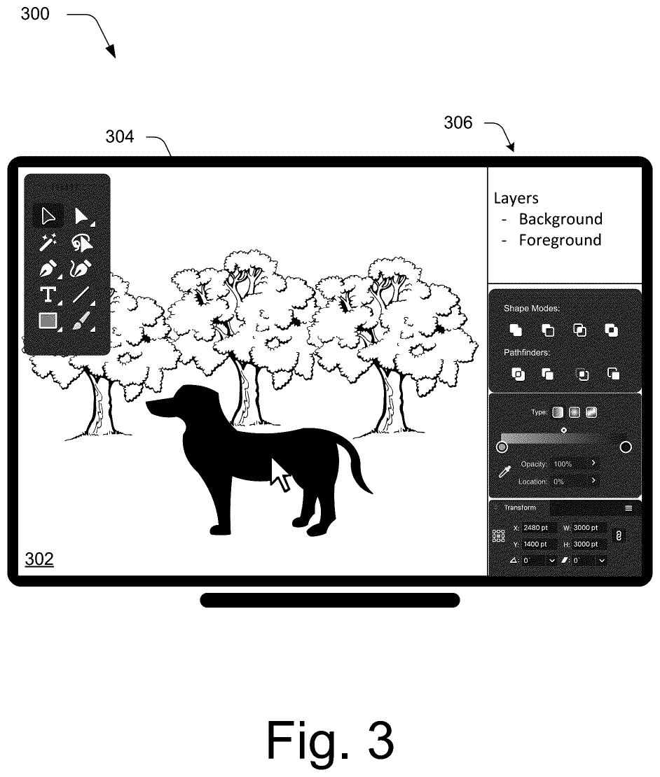

As shown in an example implementation 300 of FIG. 3, for instance, a user interface 302 is output that is configured to edit digital content configured as a digital image 304. The digital image 304 includes a plurality of layers 306 and the user interface 302 includes a plurality of representations of edit operations that are applicable to the digital image 304 to change color values of respective pixels that form the digital image 304. A user input, for instance, is received through manipulation of a cursor control device to select a digital object (e.g., a dog) and edit visual characteristics of the digital object, e.g., to change a color, location, rotation, size, and so forth.

Returning again to FIG. 2, the edit input 204 is received by the edit operation module 206 and used to form edited digital content 208 from a first local version of digital content 120. The edit operation module 206, for instance, initiates the edit operation as selected by the edit input 204. The edited digital content is then passed as an input to a first client coedit module 132 to implement digital content coediting as part of a coediting session with another client device, e.g., the second client device 106.

The first client coedit module 132 begins in this example by utilizing an action identifier module 210 to identify the edit 212 and assign an action identifier (e.g., illustrated as action ID 214) to the edit 212 (block 504). The edit 212, for instance, describes the edit input 204 that is received to generate the edited digital content 208. In an implementation, the edit 212 is specified as a patch as part of a delta computed to optimize processing speed and network communication as further described below.

An element identifier module 216 is then employed to obtain an element identifier 218 of an element of the digital content that is a subject of the edit of the element and a previous action identifier 220 identifying a previous edit associated with the element (block 506). The element identifier module 216, for instance, detects an element that is a subject of the edit input 204, e.g., a layer of a digital image, page of a digital document, and so forth. The element identifier 218 is therefore used to identify that element. The previous action identifier 220 identifies a most recent edit made to that element, and as such, describes a state of the element that is a subject of the edit and therefore “what” is being edited by the edit 212.

In an implementation, an edit region detection module 222 is also employed to detect an edited content region 224 of the digital content corresponding to the edit 212 (block 508). For example, the edit region detection module 222 employs tile-based incremental synchronization of pixel data in a coediting session which reduces an amount of data to be communicated and processed by respective service provider systems and client devices. To do so, the edit region detection module 222 detects which subregion of the elements (e.g., layers) are a subject of the edit 212 and generates the edited content region 224 as a subregion of the element that is changed.

In some instances, substantial amounts of data are synchronized as part of a digital content coediting session, such as to send pixel data for coediting of layers of a digital image. To address these technical challenges, the edit region detection module 222 is also configurable to employ “delta” techniques that are usable to improve computational and storage efficiency and reduce power consumption. The delta is generated by the edit region detection module 222 between a before-state of an in-memory representation of the digital content before the edit and an after-state of the in-memory representation of the digital content after the edit (block 510). The delta is then split into two pieces, a patch which describes edits made to the digital content (e.g., the edit 212) and binary data referenced by the patch describing e.g. color values of pixels involved in the edit.

As part of generation of the delta, the edit region detection module 222 is also configurable to employ validation techniques in support of legacy applications, e.g., which do not have current support for correctly computing the delta for each part of an in-memory representation of the digital content, such as a document model. If an edit is made that modified a region of digital content that is not supported comparison of the in-memory representations, then the computed delta may be incorrect and the contents of the local version of the digital content and other versions of the digital content that are maintained on other client devices as part of a coediting session may be different.

To support edit event sharing in such a scenario, a delta validation technique is performed before sending the candidate edit event over the network. This technique entails creating a local copy of the digital content by the first content editing module 116 based on the state before the edit 212 was made and then applying the delta onto the copy. The original edited version of the digital content is then compared to the copy of the digital content, to which, with the generated delta is applied. If the original and copy do not match, an edit 212 has been made that is not yet supported. Therefore, the edit 212 is reverted locally by the first client coedit module 132 and is not sent to other client devices that are participating in the digital content coediting session to protect against divergence of corresponding states of the digital content.

A candidate event generation module 226 is then employed to generate the candidate edit event 136 (block 512). The candidate edit event 136, for instance, includes the action ID 214, the element identifier 218, and the previous action identifier 220. The candidate edit event 136 may also include the edited content region, e.g., as an edit 212 specified via a patch and binary data corresponding to the edited content region 224. The candidate edit event 136 is then transmitted by the first client device 104 via the network 108 for receipt by the service provider system 102 (block 514).

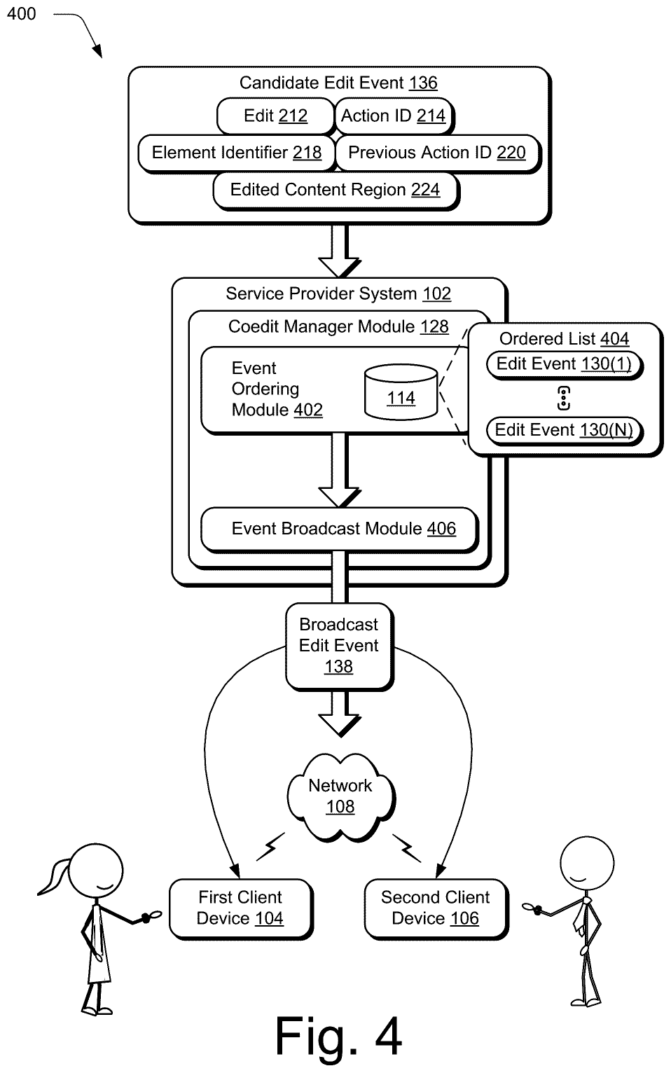

FIG. 4 depicts a system 400 in an example implementation showing receipt by the service provider system 102 of the candidate edit event 136 and generation of a broadcast edit event 138 which is broadcast to client devices that participate in a digital content coediting session. In the illustrated example, the candidate edit event 136 includes the edit 212, the action ID 214, the element identifier 218, the previous action identifier 220, and the edited content region 224. The edit 212, for instance, is specified via a patch and the edited content region 224 includes binary data as generated using the delta techniques described above.

The coedit manager module 128 of the service provider system 102 employs an event ordering module 402 to maintain an ordered list 404 of edit events, examples of which are illustrated as edit events 130(1)-130(N). The module 402 is maintained as a strict ordering as the candidate edit events 136 are received by the service provider system 102 that are broadcast by an event broadcast module 406 as a broadcast edit event 138.

Continuing with the delta example, the edited content region 224 is maintained locally in storage device 114 at the service provider system 102 whereas the edit 212 (e.g., a patch) described the edit is included in the broadcast edit event 138. This reduces an amount of time and resources employed to transmit the broadcast edit event 138 to the first client device 104 and the second client device 106, thereby also reducing a chance of conflict occurring during communication via the network as well as improving operational and computational efficiency.

Deltas as generated above, for instance, are split into a relatively small parametric “patch” that describes the changes being made to the digital content, and a larger store of arbitrary binary data, e.g., raster data, color profile data, and so on. Because the binary data can be cumbersome relative to the size of the patch, the two pieces may be split apart and transmitted to different services of the service provider system 102. The patch, for instance, is sent to a live edit service, where it is numbered among the other patches being applied to the digital content. The binary data (e.g., raster data) is compressed and uploaded to a separate store for storage.

Accordingly, a broadcast edit event 138 that includes the patch may be utilized to determine whether the edit is to be applied as part of a conflict resolution determination. The binary data associated with the patch is downloaded responsive to a determination that the edit is to be applied. By splitting the transmission into a relatively lightweight schema and a relatively heavyweight binary data, bandwidth is optimized along with a quicker determination of whether to apply a corresponding edit, thereby reducing an amount of time that conflicting edits may occur. Further discussion of receipt of the broadcast edit event 138 as part of digital content coediting is included in the following section and shown in corresponding figures.

### Broadcast Edit Event Resolution in Digital Content Coediting

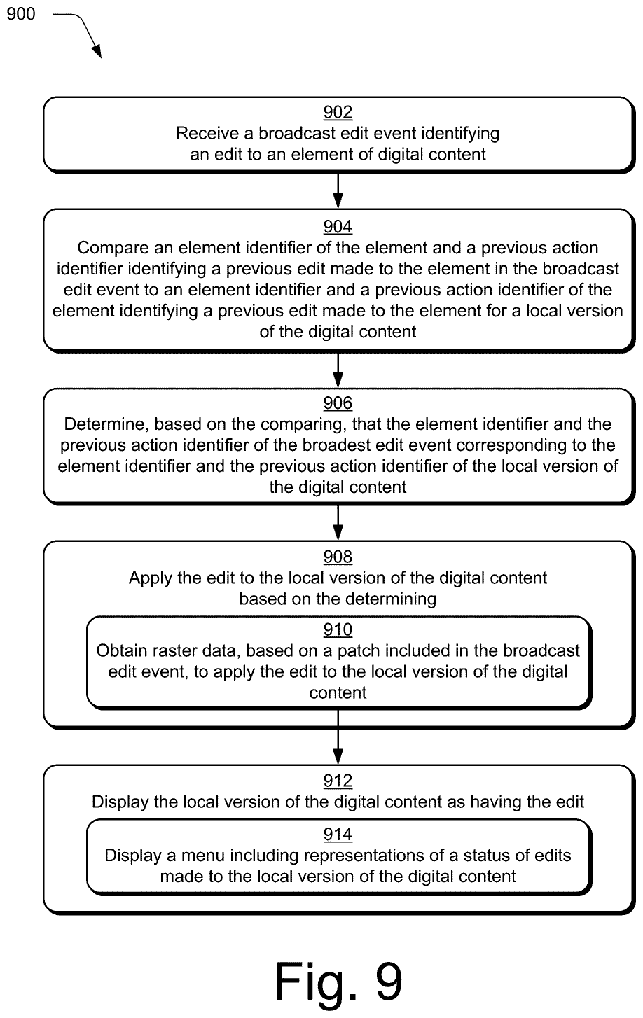

The following discussion describes broadcast edit event resolution techniques that are implementable utilizing the described systems and devices. Aspects of the procedure are implemented in hardware, firmware, software, or a combination thereof. The procedure is shown as a set of blocks that specify operations performable by hardware and are not necessarily limited to the orders shown for performing the operations by the respective blocks. Blocks of the procedure, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. In portions of the following discussion, reference will be made in parallel to FIG. 9, which is a flow diagram depicting an algorithm 900 as a step-by-step procedure in an example implementation of operations performable for accomplishing a result of receipt of a broadcast edit event, conflict determination, and resolution as part of a digital content coediting session.

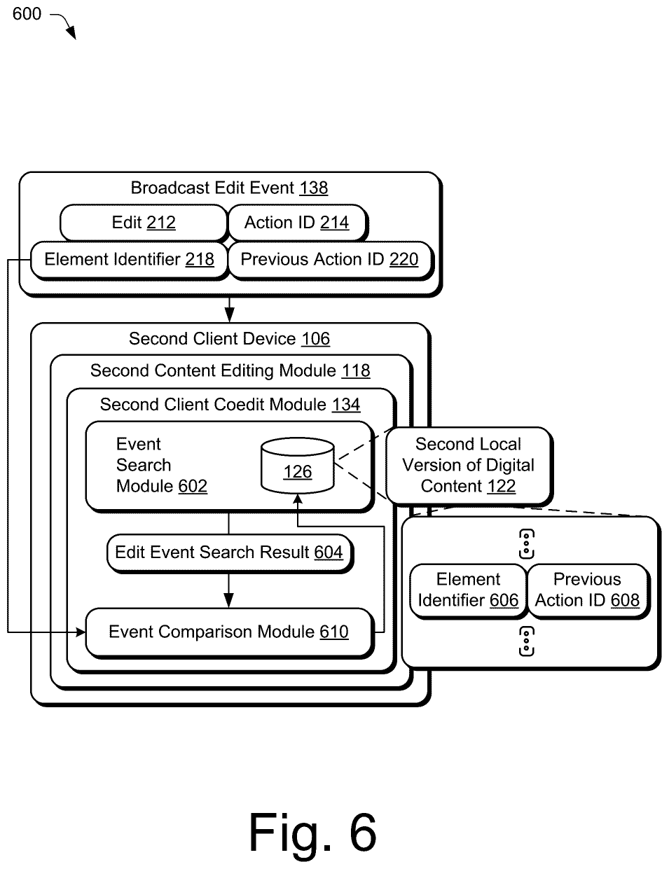

FIG. 6 depicts a system 600 in an example implementation in which a broadcast edit event 138 as transmitted by the service provider system 102 of FIG. 4 is processed by a second client device 106 as part of a digital content coediting session. To begin in this example, the broadcast edit event 138 is received by the second client device 106 (block 902). The broadcast edit event 138 identifies an edit 212 (e.g., as a patch) to an element of digital content. The broadcast edit event 138 also identifies “what” is edited through use of an element identifier 218 and a previous action identifier 220 that forms a pair that identifies a state of the identified element, e.g., a layer of a digital image and what edits are applied to the layer through a previous action identifier 220.

An event search module 602 of the second client coedit module 134 is then used to search a second local version of digital content 122 maintained in a respective local storage device 126 of the second client device 106 to generate an edit event search result 604. The event search module 602, for instance, locates an element identifier 606 of the second local version of the digital content 122 and corresponding previous action ID 608 of that event. The edit event search result 604 having the element identifier 606 and previous action ID 608 are then output to an event comparison module 610.

The event comparison module 610 is configured to compare an element identifier 218 of the element and a previous action identifier 220 identifying a previous edit made to the element in the broadcast edit event 138 to an element identifier 606 and a previous action ID 608 of the element identifying a previous edit made to the element for a local version of the digital content (block 904), e.g., the second local version of the digital content 122. A determination is then made in this example, based on the comparison, that the element identifier and the previous action identifier of the broadcast edit event correspond to the element identifier and the previous action identifier of the local version of the digital content (block 906). In this way, the event comparison module 610 is usable to determine whether the edit 212 specified by the broadcast edit event 138 is made with respect to a same state of the digital content as that maintained by the second local version of the digital content 122, e.g., based on whether the pairs match.

Continuing with this example in which the pairs correspond to each other, the edit is applied to the local version of the digital content based on the determination (block 908). As part of this, the binary data is obtained (e.g., the edited content region 224), which is based on a patch (e.g., the edit 212) included in the broadcast edit event 138, to apply the edit to the local version of the digital content (block 910). The binary data, for instance, is included in an object model as part of the second local version of the digital content 122. In this way, the edited content region 224 is not communicated in this example until a determination is made that a conflict has not occurred. The element identifier 606 and previous action ID 608 are also updated to document the edit and a corresponding state of the elements that form the second version of the digital content 122. The local version of the digital content is then displayed as having the edit (block 912), e.g., in a user interface.

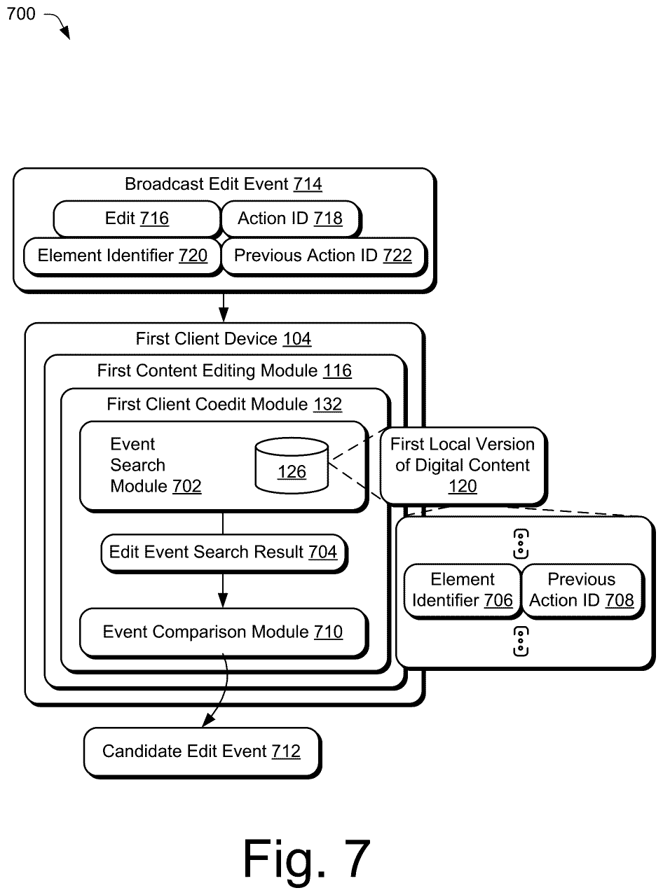

FIG. 7 depicts a system 700 in an example implementation in which a broadcast edit event as transmitted by the service provider system 102 of FIG. 4 is processed by the first client device 104 that originated the candidate edit event 136 as part of a digital content coediting session. The first content editing module 116 of the first client device 104, similar to the second content editing module 118 of the second client device 106, Includes an event search module 702 configured to generate an edit event search result 704. An element identifier 706 and previous action ID 708 are also maintained in a respective local storage device 126 as defining edits made to a first local version of digital content 120. An event comparison module 710 is configured to determine correspondence and resolve conflicts as previously described.

In this example, the first client coedit module 132 has originated a candidate edit event 712. A broadcast edit event 714 is then received that identifies an edit 716, action ID 718, and a pair formed from an element identifier 720 and a previous action ID 722. The element identifier 720 is used as a basis of a search performed by the event search module 702 to generate the edit event search result 704.

The event comparison module 710 looks up element identifier 720 of the broadcast edit event 714 in the first local version of digital content 120 to find the associated previous action ID 708 of the first local version of digital content 120 and then determines in this example that the previous action ID 722 of the broadcast edit event 714 does not correspond to the previous action ID 708 of the first local version of digital content 120. In this scenario, therefore, the broadcast edit event 714 corresponds to an edit made by another entity that is received by the service provider system 102 before receipt of the candidate edit event 712.

Accordingly, given that the first event received by the service provider system 102 is given preference among conflicting candidate events the event comparison module 710 causes removal of the candidate edit event 712 from the first local version of digital content 120 and instead includes the edit specified by the broadcast edit event 714. The edit 716, for instance, is used to obtain raster data and the element identifier 706 and the previous action ID 708 are updated. Subsequent receipt of a broadcast edit event from the service provider system 102 corresponding to the candidate edit event 712, for instance, is then rejected by each of the participating client devices in the digital content coediting session as not corresponding to a state of the digital content. In this way, each of the client devices that participate in a digital content coediting session are configured to determine, locally, which edits to apply to local versions of the digital content based on the strict ordering of the broadcast edit events imposed by the service provider system 102.

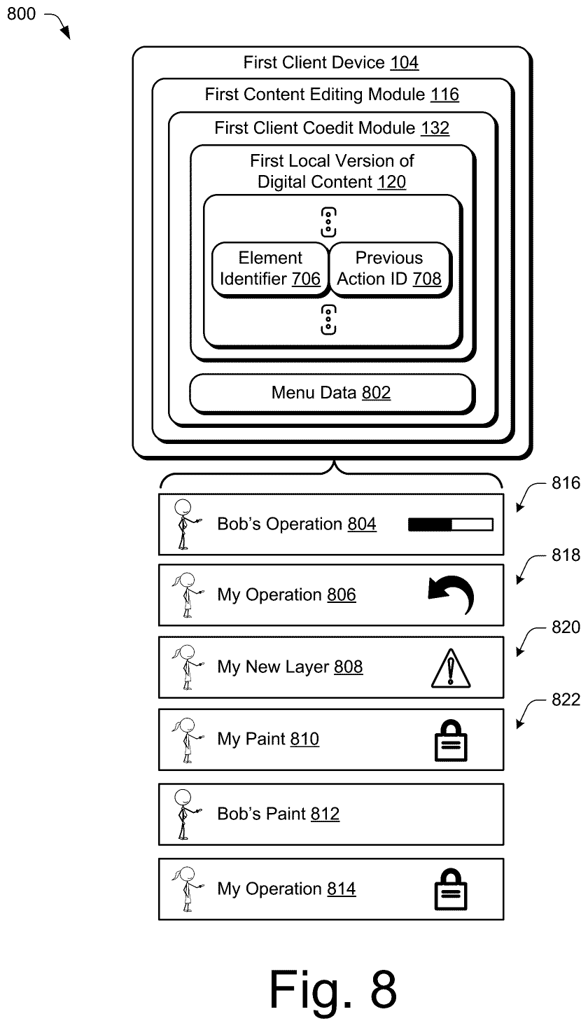

FIG. 8 depicts an example implementation 800 of output of representations indicating status of edits made to a local version of digital content. The first client device 104 includes menu data 802 is this example which is renderable for display of a menu in a user interface. The menu data, once rendered, causes display of representations of a status of edits made to the local version of the digital content in a menu (block 914). As shown in FIG. 8, for instance, a plurality of representations 804, 806, 808, 810, 812, 814 are shown that indicate an originator of a respective edit and the edit performed. The representations also indicate a status of the edits, including a download status 816 of a respective edit, whether an undo operation 818 to reverse application of a respective edit is supported, a representation of a conflict 820, whether an edit is locked 822 from being “undone” by an undo operation, and so forth. In another example, if a local edit is “conflicted out,” the representations are configured to indicate that the local edit is removed, a source of the edit that caused the conflict, and proposed remedies for the conflict, e.g., copying the conflicted edit to another edit for manual reconciliation. Accordingly, a representation is output indicating invalidation of an undo/redo operation caused by an edit made to a same element by another entity

The menu data 802, for instance, may be output as part of an undo/redo stack for each entity in a coediting session. In some instances, edits result in destructive changes, e.g., to pixels as part of digital image editing. Therefore, if another entity makes a change to an element that the local entity had previously modified and has a corresponding entry in the local undo/redo stack, it is no longer possible to correctly perform the local undo/redo operation after the other entity's change. Therefore, if entity user makes changes to one of the elements that the local user references in the local undo/redo stack, then the edits are unavailable for undo/redo because it is no longer possible to apply the undo/redo operation. The edits, for instance, are not undoable until and unless a subsequent edit is received the reverse the edit operation made subsequent to the local entity's original edit. In other words, if entities A then B both modify a same layer, entity B can still undo their operation, and if they do, user A is then able to undo theirs as well. If user B does not undo their operation, user A cannot undo theirs.

In an implementation, the ability to make edits to the authoritative version of the document in persisted the cloud is limited to a singular document engine hosted in the cloud, while other modules are limited to read-only access and use a separate communication mechanism to send coediting deltas that describe incremental changes to the document.

Further, functionality may also be supported to provide comments in real time as the edits are made, for example, an entity may indicate “Now I'm going to use clone stamp tool to cover parts of the digital” and have this message to appear pointing at the clone stamp tool for each of the other entities to also select and try.

Accordingly, digital content coediting techniques described above support coediting functionality to legacy applications and complex object models. The digital content coediting techniques also support improved computational efficiency and reduced power consumption for items of digital content that consume significant amounts of data storage, e.g., for large digital images having multiple layers, each supporting a multitude of pixels.

### Example System and Device

FIG. 10 illustrates an example system generally at 1000 that includes an example computing device 1002 that is representative of one or more computing systems and/or devices that implement the various techniques described herein. This is illustrated through inclusion of the first client coedit module 132 and the coedit manager module 128. The computing device 1002 is configurable, for example, as a server of a service provider, a device associated with a client (e.g., a client device), an on-chip system, and/or any other suitable computing device or computing system.

The example computing device 1002 as illustrated includes a processing device 1004, one or more computer-readable media 1006, and one or more I/O interface 1008 that are communicatively coupled, one to another. Although not shown, the computing device 1002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1004 is representative of functionality to perform one or more operations using hardware. Accordingly, the processing device 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012 that stores instructions that are executable to cause the processing device 1004 to perform operations. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing device 1004. The instructions and/or functions are executable/operable by one or more articles of manufacture (for example, one or more computing devices 1002 and/or processing devices 1004) to implement techniques, modules, and examples described herein.

The techniques described herein are supported by various configurations of the computing device 1002 and are not limited to the specific examples of the techniques described herein. This functionality is also implementable all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a broadcast edit event identifying an edit to an element of digital content;
comparing, by the processing device, an element identifier of the element and a previous action identifier identifying a previous edit made to the element in the broadcast edit event to an element identifier of the element and an action identifier of the element identifying a previous edit made to the element for a local version of the digital content;
determining, by the processing device, based on the comparing that the element identifier and the previous action identifier of the broadcast edit event correspond to the element identifier and the previous action identifier of the local version of the digital content;
applying, by the processing device, the edit to the local version of the digital content based on the determining; and
displaying, by the processing device, the local version of the digital content as having the edit in a user interface.

2. The method as described in claim 1, wherein the broadcast edit event includes a patch that describes the edit and the applying includes obtaining binary data based on the patch to apply the edit to the local version of the digital content.

3. The method as described in claim 2, wherein the obtaining of the binary data is performed subsequent and responsive to the determining the element identifier and the previous action identifier of the broadcast edit event corresponds to the element identifier and the previous action identifier of the local version of the digital content.

4. The method as described in claim 2, wherein the patch and the binary data are computed as a delta between a before-state of an in-memory representation of the digital content before the edit and an after-state of the in-memory representation of the digital content after the edit.

5. The method as described in claim 1, wherein the broadcast edit event is received in a broadcast from a service provider system, the service provider system imposing an ordering of broadcast edit events as candidate edit events are received by the service provider system from respective client devices that edit the digital content.

6. The method as described in claim 1, wherein the broadcast edit event is:
received in a broadcast from a service provider system; and
generated from a candidate edit event received by a service provider system from a first client device.

7. The method as described in claim 6, wherein the previous action identifier identifying the previous edit made to the element in the broadcast edit event is included in the candidate edit event received by the service provider system from the first client device.

8. The method as described in claim 1, wherein the displaying includes displaying a menu in the user interface including representations of a status of edits made to the local version of the digital content.

9. The method as described in claim 8, wherein the representations indicate whether a respective said edit is locked, a download status of a respective said edit, or whether an undo operation to reverse application of a respective said edit is supported.

10. The method as described in claim 8, wherein the displaying includes a representation indicating invalidation of an undo/redo operation caused by an edit made to a same said element by another entity.

11. A system comprising:
an edit operation module implemented by a processing device to receive an edit input specifying an edit to digital content;
an action identifier module implemented by the processing device to assign an action identifier to the edit;
an element identifier module implemented by the processing device to obtain an element identifier of an element of the digital content that is a subject of the edit of the element and a previous action identifier identifying a previous edit associated with the element;
an edit region detection module implemented by the processing device to detect an edited content region of the digital content corresponding to the edit; and
a candidate event generation module implemented by the processing device to generate a candidate edit event including the action identifier, the element identifier, the previous action identifier, and the edited content region.

12. The system as described in claim 11, wherein the candidate event generation module includes a delta computation module configured to generate a delta between a before-state of an in-memory representation of the digital content before the edit and an after-state of the in-memory representation of the digital content after the edit.

13. The system as described in claim 12, wherein the delta computation module is configured to split the delta into:
a patch that describes the edit; and
binary data corresponding to the patch to apply the edit.

14. The system as described in claim 13, wherein the candidate edit event is communicated to a service provider system that includes the patch and the binary data.

15. The system as described in claim 14, wherein the patch is configured for inclusion in a broadcast edit event by the service provider system, the broadcast edit event referencing the binary data as stored at the service provider system and obtainable separately from the patch.

16. The system as described in claim 11, wherein the edit region detection module supports a validation technique configured to restrict communication of an unsupported edit.

17. One or more computer-readable storage media storing instruction that, responsive to execution by a processing device, causes the processing device to perform operations comprising:
receiving an edit input specifying an edit to a digital image;
assigning an action identifier to the edit;
identifying an element of the digital image that corresponds to the edit;
obtaining an element identifier of the layer and a previous action identifier identifying a previous edit associated with the element;
detecting a portion of the layer that is a subject of the edit; and
generating a candidate edit event to control coediting of the digital image, the candidate edit event including the portion, the action identifier, the element identifier, and the previous action identifier.

18. The one or more computer-readable storage media as described in claim 17, wherein the operations further comprise generating a delta between a before-state of an in-memory representation of the digital image before the edit and an after-state of the in-memory representation of the digital image after the edit.

19. The one or more computer-readable storage media as described in claim 18, wherein generating includes splitting the delta into:
a patch that describes the edit; and
binary data corresponding to the patch to apply the edit.

20. The one or more computer-readable storage media as described in claim 19, further comprising receiving a edit event in a broadcast and removing a conflicting candidate edit from a local version of the digital image.
